(19) United States
(12) Patent Application Publication
(10) Pub. No.: US 2021/0017338 A1
(43) Pub. Date: Jan. 21, 2021

(54) SILANE-MODIFIED POLYETHER SEALANT AND PREPARATION METHOD AND USE THEREOF

(71) Applicant: Guangzhou Glorystar Chemical Co., Ltd., Guangzhou City (CN)

(72) Inventors: Xinsong Hu, Guangzhou City (CN); Xiaolian Cheng, Guangzhou City (CN); Jun Zeng, Guangzhou City (CN); Chao Zhu, Guangzhou City (CN); Fajin Diao, Guangzhou City (CN); Wenlong Xia, Guangzhou City (CN); Xianglei Zeng, Guangzhou City (CN); Haoying Chen, Guangzhou City (CN); Zhehui Qu, Guangzhou City (CN); Wanhua Li, Guangzhou City (CN); Yangjie Cao, Guangzhou City (CN); Yaozhong Li, Guangzhou City (CN); Lihua Deng, Guangzhou City (CN)

(73) Assignee: Guangzhou Glorystar Chemical Co., Ltd., Guangzhou City (CN)

(21) Appl. No.: 16/930,549

(22) Filed: Jul. 16, 2020

(30) Foreign Application Priority Data
Jul. 19, 2019 (CN) 201910655152.8

(51) Int. Cl. C08G 77/14; C08G 77/06; C08G 77/26; C09J 4/06; C09J 11/08; C08K 3/26; C08K 3/22

(52) U.S. Cl. CPC C08G 77/14; C08G 77/06; C08G 77/26; C09J 4/06; C08K 2003/2241; C08K 3/26; C08K 3/22; C08K 2003/265; C08K 2201/011; C09J 11/08

(57) ABSTRACT

Silane-modified polyether sealant and preparation methods and uses thereof The silane-modified polyether sealant includes the following raw materials: a silane-modified polyether resin, a plasticizer, a drilling agent, a filler, an adhesion promoter and a catalyst. In the present invention, various coupling agents are hydrolyzed and cross-linked to form an oligomer as the adhesion promoter. Compared with ordinary silane coupling agents, the oligomer coupling agent has higher activity to promote deep curing of the adhesive. In addition, compared with ordinary catalysts, the catalyst prepared by the present invention has higher catalytic activity. It accelerates the hydrolysis, crosslinking and curing of the adhesive, thus helping to obtain a uniformly dispersed, thixotropic single-component silane-modified polyether sealant.

### CROSS-REFERENCE TO RELATED APPLICATION

This application claims the benefit of priority from CN 201910655152.8 filed on Jul. 19, 2019 entitled “SILANE-MODIFIED POLYETHER SEALANT AND PREPARATION METHOD AND USE THEREOF,” the entirety of which is incorporated by reference herein.

### TECHNICAL FIELD

The present invention belongs to the technical field of sealants, and particularly relates to a silane-modified polyether sealant and a preparation method and use thereof.

### BACKGROUND

Copper is one of the most valued metals today. The change in copper demand has become an important indicator of measuring society, economy and quality of life. With the progress of society and the continuous development of economy, the application of copper has become a new indicator to measure the level of economic development. Nowadays, copper is widely used in traditional architecture, tiles, bucket arches, doors and windows, Buddhist altars, couplets, murals, sculptures and other structures in the field of architectural decoration, making them more elegant.

In the production process of copper doors, it is necessary to use adhesives to glue copper ornaments to the doors to improve the aesthetics of the copper doors. Adhesives are also required to assemble the copper doors. The decoration and assembly of copper doors require that the adhesives have appropriate initial bonding strength. If the initial bonding strength is insufficient, the copper ornaments will fall off due to high density, affecting the production efficiency of copper doors. The initial bonding strength is mainly embodied by the initial curing speed and shear strength of the adhesives. At present, alcohol-based silicone adhesives are commonly used to glue copper doors. Because of low initial curing speed and shear strength, the alcohol-based silicone adhesives take a long time to cure before the next procedure, which greatly affects the production efficiency.

### SUMMARY

An objective of the present invention is to provide a silane-modified polyether sealant and a preparation method thereof. The silane-modified polyether sealant has high initial curing speed and shear strength, and the preparation method is efficient. Another objective of the present invention is to provide use of the silane-modified polyether sealant in the assembly of a copper structure. The silane-modified polyether sealant meets the high requirements of copper doors and other copper structures for the initial bonding strength and is quick to bond, improving the bonding and assembly efficiencies of the copper structures.

The present invention adopts the following technical solutions:

A silane-modified polyether sealant, including the following parts by weight of raw materials: 15-30 parts of silane-modified polyether resin, 10-20 parts of plasticizer, 0.5-2 parts of drying agent, 30-70 parts of filler, 1-3 parts of adhesion promoter and 0.1-0.5 parts of catalyst.

Preferably, the silane-modified polyether resin is a silane-terminated polyether with hydrolysable trimethoxy as a terminal group, such as HMS-1207 of Zhejiang Huangma Chemical Industry Group Co., Ltd. and 30000T of Risun Polymer International Co., Ltd. More preferably, the silane-modified polyether resin accounts for 17-30 parts by weight.

Preferably, the plasticizer is at least one of diisononyl phthalate (DINP), diisodecyl phthalate (DIDP), diisononyl cyclohexane 1,2-dicarboxylate (DINCH) and polypropylene glycol (PPG).

Preferably, the drying agent is vinyl trimethoxysilane (VTMS).

Preferably, the filler is at least one of ground calcium carbonate (GCC), nano calcium carbonate (NCC), quartz powder, silica, titanium dioxide (TD) and carbon black.

Preferably, the adhesion promoter is prepared by the following method: adding N-β-(aminoethyl)-γ-aminopropyltrimethoxysilane, 2-(3,4-epoxycyclohexane)ethyltrimethoxysilane, n-octyltriethoxysilane and water in a molar ratio of 1:(0.4-0.6):(0.4-0.6):(0.25-0.35) into a three-necked flask; stirring at 50-60° C. under nitrogen for 2-3 h; and cooling down to obtain the adhesion promoter. More preferably, the molar ratio of the N-β-(aminoethyl)-γ-aminopropyltrimethoxysilane, 2-(3,4-epoxycyclohexane)ethyltrimethoxysilane, n-octyltriethoxysilane and water is 1:0.5:0.5:0.3. Compared with the conventional hydrolytic polymerization of aminosilane and epoxysilane, this method introduces the long-chain n-octyltriethoxysilane, which increases the molecular weight for hydrolytic polymerization. In this way, the present invention better promotes the deep penetration of water vapor in the adhesive, thereby accelerating the deep solidification of the adhesive, and improving the adhesion of the adhesive to inorganic materials such as copper.

Preferably, the catalyst is prepared by the following method: adding dibutyltin dilaurate (DBTDL), stannous octoate and primary dodecyl amine into a three-necked flask in a mass ratio of (4-6):(4-6):3, and stirring at 10-20° C. under nitrogen for 1-2 h to obtain the catalyst. More preferably, the mass ratio of the DBTDL, stannous octoate and primary dodecyl amine is 5:5:3.

The present invention further provides a method for preparing the above-mentioned silane-modified polyether sealant, including the following steps: adding the silane-modified polyether resin, plasticizer and filler into a stirring reactor at room temperature; stirring under vacuum for 3-10 min, heating up to 100-110° C., dehydrating under vacuum for 2-3 h; cooling down to 25-50° C.; adding the drying agent, adhesion promoter and catalyst in sequence; stirring for 20-40 min under vacuum to obtain the silane-modified polyether sealant that is uniformly dispersed and thixotropic.

Compared with the prior art, the present invention has the following beneficial effects.

In the present invention, various coupling agents including n-octyltriethoxysilane are hydrolyzed and cross-linked to form an oligomer as the adhesion promoter. Compared with ordinary silane coupling agents, conventional aminosilanes and epoxysilanes, the oligomer coupling agent prepared by the present invention has higher activity to promote deep curing of the adhesive. In addition, compared with ordinary catalysts, the catalyst prepared by the present invention has higher catalytic activity. It accelerates the hydrolysis, crosslinking and curing of the adhesive, thus helping to obtain a uniformly dispersed, thixotropic single-component silane-modified polyether sealant. The silane-modified polyether sealant provided by the present invention is widely used. The preparation method is efficient, and the prepared silane-modified polyether sealant has stable quality. The present invention further provides use of the silane-modified polyether sealant in the assembly of copper structures. The silane-modified polyether sealant meets the high requirements of copper doors and other copper structures for the initial bonding strength, and is quick to bond, improving the bonding and assembly efficiencies of the copper structures.

### DETAILED DESCRIPTION

The present invention is further described below with reference to the examples, but the examples are not intended to limit the present invention.

In the following examples, the raw materials are commercially available products, except for the adhesion promoter and catalyst, which are prepared by the present invention as follows: preparation of adhesion promoter: add 1 mol of N-β-(aminoethyl)-65 -aminopropyltrimethoxysilane, 0.5 mol of 2-(3,4-epoxycyclohexane)ethyltrimethoxysilane, 0.5 mol of n-octyltriethoxysilane and 0.3 mol of water into a 1 L three-necked flask; stir at 50-60° C. under nitrogen for 2 h; and cool down to obtain the adhesion promoter;

preparation of catalyst: add 200 g of dibutyltin dilaurate (DBTDL), 200 g of stannous octoate and 120 g of primary dodecyl amine into a 1 L three-necked flask, and stir at 10-20° C. under nitrogen for 1 h to obtain the catalyst.

### EXAMPLE 1

A silane-modified polyether sealant, including the following parts by weight of raw materials: 20 parts of silane-modified polyether resin, 15 parts of diisononyl cyclohexane 1,2-dicarboxylate (DINCH), 0.5 parts of vinyl trimethoxysilane (VTMS), 20 parts of ground calcium carbonate (GCC), 40 parts of nano calcium carbonate (NCC), 3 parts of titanium dioxide (TD), 1.5 parts of adhesion promoter and 0.2 parts of catalyst.

Preparation steps: add the silane-modified polyether resin, DINCH, GCC, NCC and TD at room temperature into a stirring reactor; stir under vacuum for 5 min; heat up to 100-110° C.; dehydrate under vacuum for 2 h; cool down under vacuum to 50° C. below; sequentially add the VTMS, adhesion promoter and catalyst; and stir under vacuum for 30 min, to obtain the silane-modified polyether sealant that is uniformly dispersed and thixotropic.

### EXAMPLE 2

A silane-modified polyether sealant, including the following parts by weight of raw materials: 25 parts of silane-modified polyether resin, 15 parts of polypropylene glycol (PPG), 1 part of VTMS, 10 parts of GCC, 45 parts of NCC, 2 parts of carbon black, 2 parts of adhesion promoter and 0.3 parts of catalyst.

Preparation steps: add the silane-modified polyether resin, PPQ GCC, NCC and carbon black at room temperature into a stirring reactor; stir under vacuum for 10 min; heat up to 100-110° C.; dehydrate under vacuum for 3 h; cool down under vacuum to 50° C. below; sequentially add the VTMS, adhesion promoter and catalyst; and stir under vacuum for 20 min, to obtain the silane-modified polyether sealant that is uniformly dispersed and thixotropic.

### EXAMPLE 3

A silane-modified polyether sealant, including the following parts by weight of raw materials: 17 parts of silane-modified polyether resin, 17 parts of diisodecyl phthalate (DIDP), 1 part of VTMS, 30 parts of NCC, 30 parts of quartz powder, 3 parts of TD, 2 parts of adhesion promoter and 0.2 parts of catalyst.

Preparation steps: add the silane-modified polyether resin, DIDP, NCC, quartz powder and TD at room temperature into a stirring reactor; stir under vacuum for 3 min; heat up to 100-110° C.; dehydrate under vacuum for 2 h; cool down under vacuum to 50° C. below; sequentially add the VTMS, adhesion promoter and catalyst; and stir under vacuum for 40 min, to obtain the silane-modified polyether sealant that is uniformly dispersed and thixotropic.

### EXAMPLE 4

A silane-modified polyether sealant, including the following parts by weight of raw materials: 30 parts of silane-modified polyether resin, 10 parts of DINCH, 1 part of VTMS, 10 parts of GCC, 45 parts of NCC, 2 parts of TD, 2 parts of adhesion promoter and 0.2 parts of catalyst.

Preparation steps: add the silane-modified polyether resin, DINCH, GCC, NCC and TD at room temperature into a stirring reactor; stir under vacuum for 5 min; heat up to 100-110° C.; dehydrate under vacuum for 3 h; cool down under vacuum to 50° C. below; sequentially add the VTMS, adhesion promoter and catalyst; and stir under vacuum for 30 min, to obtain the silane-modified polyether sealant that is uniformly dispersed and thixotropic.

### COMPARATIVE EXAMPLE 1

A silane-modified polyether sealant, including the following parts by weight of raw materials: 20 parts of silane-modified polyether resin, 15 parts of DINCH, 0.5 parts of VTMS, 20 parts of GCC, 40 parts of NCC, 3 parts of TD, 1.5 parts of N-β-(aminoethyl)-γ-aminopropyltrimethoxysilane and 0.2 parts of dibutyltin dilaurate (DBTDL).

Preparation steps: add the silane-modified polyether resin, DINCH, GCC, NCC and TD at room temperature into a stirring reactor; stir under vacuum for 5 min; heat up to 100-110° C.; dehydrate under vacuum for 2 h; cool down under vacuum to 50° C. below; sequentially add the VTMS, N-β-(aminoethyl)-γ-aminopropyltrimethoxysilane and DBTDL; and stir under vacuum for 30 min, to obtain the silane-modified polyether sealant.

### COMPARATIVE EXAMPLE 2

A silane-modified polyether sealant, including the following parts by weight of raw materials: 20 parts of silane-modified polyether resin, 15 parts of DINCH, 0.5 parts of VTMS, 20 parts of GCC, 40 parts of NCC, 3 parts of TD, 1.5 parts of N-β-(aminoethyl)-γ-aminopropyltrimethoxysilane and 0.2 parts of catalyst.

Preparation steps: add the silane-modified polyether resin, DINCH, GCC, NCC and TD at room temperature into a stirring reactor; stir under vacuum for 5 min; heat up to 100-110° C.; dehydrate under vacuum for 2 h; cool down under vacuum to 50° C. below; sequentially add the VTMS, N-β-(aminoethyl)-γ-aminopropyltrimethoxysilane and catalyst; and stir under vacuum for 30 min, to obtain the silane-modified polyether sealant.

### COMPARATIVE EXAMPLE 3

A silane-modified polyether sealant, including the following parts by weight of raw materials: 20 parts of silane-modified polyether resin, 15 parts of DINCH, 0.5 parts of VTMS, 20 parts of GCC, 40 parts of NCC, 3 parts of TD, 1.5 parts of adhesion promoter and 0.2 parts of DBTDL.

Preparation steps: add the silane-modified polyether resin, DINCH, GCC, NCC and TD at room temperature into a stirring reactor; stir under vacuum for 5 min; heat up to 100-110° C.; dehydrate under vacuum for 2 h; cool down under vacuum to 50° C. below; sequentially add the VTMS, adhesion promoter and DBTDL; and stir under vacuum for 30 min, to obtain the silane-modified polyether sealant.

### COMPARATIVE EXAMPLE 4

A silane-modified polyether sealant, including the following parts by weight of raw materials: 20 parts of silane-modified polyether resin, 15 parts of DINCH, 0.5 parts of VTMS, 20 parts of GCC, 40 parts of NCC, 3 parts of TD, 1.5 parts of Dynasylan®1146 coupling agent and 0.2 parts of DBTDL.

Preparation steps: add the silane-modified polyether resin, DINCH, GCC, NCC and TD at room temperature into a stirring reactor; stir under vacuum for 5 min; heat up to 100-110° C.; dehydrate under vacuum for 2 h; cool down under vacuum to 50° C. below; sequentially add the VTMS, Dynasylan®1146 coupling agent and DBTDL; and stir under vacuum for 30 min, to obtain the silane-modified polyether sealant.

### COMPARATIVE EXAMPLE 5

A silane-modified polyether sealant, including the following parts by weight of raw materials: 20 parts of silane-modified polyether resin, 15 parts of DINCH, 0.5 parts of VTMS, 20 parts of GCC, 40 parts of NCC, 3 parts of TD, 1.5 parts of CapatueTMSCA-HE87M and 0.2 parts of DBTDL.

Preparation steps: add the silane-modified polyether resin, DINCH, GCC, NCC and TD at room temperature into a stirring reactor; stir under vacuum for 5 min; heat up to 100-110° C.; dehydrate under vacuum for 2 h; cool down under vacuum to 50° C. below; sequentially add the VTMS, CapatueTMSCA-HE87M and DBTDL; and stir under vacuum for 30 min, to obtain the silane-modified polyether sealant.

### COMPARATIVE EXAMPLE 6

A silane-modified polyether sealant, including the following parts by weight of raw materials: 20 parts of silane-modified polyether resin, 15 parts of DINCH, 0.5 parts of VTMS, 20 parts of GCC, 40 parts of NCC, 3 parts of TD, 1.5 parts of adhesion promoter, 0.2 parts of DBTDL and 0.1 parts of triethylamine (TEA).

Preparation steps: add the silane-modified polyether resin, DINCH, GCC, NCC and TD at room temperature into a stirring reactor; stir under vacuum for 5 min; heat up to 100-110° C.; dehydrate under vacuum for 2 h; cool down under vacuum to 50° C. below; sequentially add the VTMS, adhesion promoter, DBTDL and TEA; and stir under vacuum for 30 min, to obtain the silane-modified polyether sealant.

### COMPARATIVE EXAMPLE 7

An alcohol-based silicone sealant, including the following parts by weight of raw materials: 35 parts of 107 gum, 10 parts of dimethyl silicone (DMS), 10 parts of GCC, 40 parts of NCC, 2 parts of titanate, 1.5 parts of VTMS, 2 parts of methyltrimethoxysilane (MTMS), 0.1 parts of y-aminopropyltrimethoxysilane and 0.2 parts of y-glycidyloxypropyltrimethoxysilane.

Preparation steps: add the 107 gum, DMS, GCC and NCC at room temperature into a stirring reactor; stir under vacuum for 5 min; heat up to 100-110° C.; dehydrate under vacuum for 2 h; cool down under vacuum to 50° C. below; add the titanate; stir under vacuum for 20 min; sequentially add the VTMS, MTMS, y-aminopropyltrimethoxysilane and y-glycidyloxypropyltrimethoxysilane; and stir under vacuum for 30 min, to obtain the alcohol-based silicone sealant.

Test Example 1: Performance Test

The silane-modified polyether sealants prepared in Examples 1 to 4 and Comparative Examples 1 to 6 and the alcohol-based silicone sealant prepared in Comparative Example 7 were subjected to performance test according to the methods as specified in GB/T 29595-2013, GB/T 13477.5-2002 and GB/T 7124-2008. The test results are shown in Table 1.

TABLE 1
Performance test results of different sealants

| | Curing | | | | | | | Surface |
|---|---|---|---|---|---|---|---|---|
| | Speed/mm | | | Shear strength/MPa | | | | drying |
| Groups | 4 h | 8 h | 24 h | 4 h | 8 h | 24 h | 48 h | time/min |
| Example 1 | 0.95 | 1.45 | 3.42 | 0.25 | 0.43 | 2.62 | 3.14 | 8 |
| Example 2 | 1.12 | 1.78 | 3.90 | 0.31 | 0.52 | 2.84 | 3.50 | 6 |
| Example 3 | 0.89 | 1.40 | 3.36 | 0.19 | 0.33 | 2.36 | 2.87 | 7 |
| Example 4 | 1.20 | 1.98 | 4.15 | 0.42 | 0.69 | 3.17 | 3.92 | 7 |
| Comparative | 0.75 | 1.24 | 2.55 | 0.15 | 0.27 | 2.12 | 2.70 | 10 |
| Example 1 | | | | | | | | |
| Comparative | 0.85 | 1.32 | 3.10 | 0.22 | 0.38 | 2.34 | 2.83 | 8 |
| Example 2 | | | | | | | | |
| Comparative | 0.88 | 1.35 | 3.24 | 0.21 | 0.36 | 2.45 | 2.92 | 10 |
| Example 3 | | | | | | | | |
| Comparative | 0.79 | 1.30 | 3.05 | 0.12 | 0.33 | 2.25 | 2.84 | 14 |
| Example 4 | | | | | | | | |
| Comparative | 0.53 | 0.95 | 2.12 | 0.07 | 0.18 | 1.65 | 2.10 | 26 |
| Example 5 | | | | | | | | |
| Comparative | 0.81 | 1.26 | 2.78 | 0.18 | 0.34 | 2.24 | 2.75 | 8 |
| Example 6 | | | | | | | | |
| Comparative | 0.62 | 0.93 | 2.45 | 0.13 | 0.21 | 1.80 | 2.42 | 18 |
| Example 7 | | | | | | | | |

The results show that, compared with the sealants prepared by Comparative Examples 1 to 7, the silane-modified polyether sealants prepared by Examples 1 to 4 of the present invention have higher initial curing speed and shear strength and shorter surface drying time. Therefore, the silane-modified polyether sealants are quick to bond, thereby significantly improving the assembly efficiency. Compared with Example 1, Comparative Example 1 replaces the adhesion promoter prepared by the present invention with N-β-(aminoethyl)-γ-aminopropyltrimethoxysilane, and replaces the catalyst prepared by the present invention with DBTDL. The initial curing speed and shear strength of the silane-modified polyether sealant prepared by the comparative example are both reduced and the surface drying time thereof is prolonged. Compared with Example 1, Comparative Examples 2 to 3 replace the adhesion promoter prepared by the present invention with N-β-(aminoethyl)-γ-aminopropyltrimethoxysilane but retain the catalyst prepared by the present invention, or replace the catalyst prepared by the present invention with DBTDL but retain the adhesion promoter prepared by the present invention. The initial curing speed and shear strength of the silane-modified polyether sealants prepared by the two comparative examples are both reduced and the surface drying time thereof is prolonged. Compared with Example 1, Comparative Examples 4 to 5 replace the adhesion promoter prepared by the present invention with commonly used aminosilane oligomer 1146 (Dynasylan® 1146 coupling agent) and epoxysilane oligomer SCA-HE87M (CapatueTMSCA-HE87M), and replace the catalyst prepared by the present invention with DBTDL. The initial curing speed and shear strength of the silane-modified polyether sealants prepared by the two comparative examples are both reduced and the surface drying time thereof is prolonged. Compared with Example 1, Comparative Example 6 replaces the catalyst prepared by the present invention with DBTDL and TEA, and the initial curing speed and shear strength of the sealant prepared by the comparative example are both reduced. The above results show compared with the commonly used alcohol-based silicone sealant (Comparative Example 7), the adhesion promoter and catalyst prepared by the present invention significantly increase the initial curing speed and shear strength of the silane-modified polyether sealant, shorten the surface drying time, and significantly improve the assembly efficiency.

The above described are merely preferred implementations of the present invention. It should be pointed out that the preferred implementations should not be construed as a limitation to the present invention, and the protection scope of the present invention should be subject to the claims of the present invention. Those of ordinary skill in the art may make several improvements and modifications without departing from the spirit and scope of the present invention, but the improvements and modifications should fall within the protection scope of the present invention.

What is claimed is:

1. A silane-modified polyether sealant, comprising the following parts by weight of raw materials: 15-30 parts of silane-modified polyether resin, 10-20 parts of plasticizer, 0.5-2 parts of drying agent, 30-70 parts of filler, 1-3 parts of adhesion promoter and 0.1-0.5 parts of catalyst.

2. The silane-modified polyether sealant according to claim 1, wherein the plasticizer is at least one of diisononyl phthalate (DINP), diisodecyl phthalate (DIDP), diisononyl cyclohexane 1,2-dicarboxylate (DINCH) and polypropylene glycol (PPG); the drying agent is vinyl trimethoxysilane (VTMS).

3. The silane-modified polyether sealant according to claim 1, wherein the filler is at least one of ground calcium carbonate (GCC), nano calcium carbonate (NCC), quartz powder, silica, titanium dioxide (TD) and carbon black.

4. A silane-modified polyether sealant comprising the following parts by weight of raw materials: 15-30 parts of a silane-terminated polyether with hydrolysable trimethoxy as a terminal group, 10-20 parts of plasticizer, 0.5-2 parts of drying agent, 30-70 parts of filler, 1-3 parts of adhesion promoter and 0.1-0.5 parts of catalyst.

5. The silane-modified polyether sealant according to claim 4 wherein the plasticizer is at least one of diisononyl phthalate (DINP), diisodecyl phthalate (DIDP), diisononyl cyclohexane 1,2-dicarboxylate (DINCH) and polypropylene glycol (PPG); the drying agent is vinyl trimethoxysilane (VTMS).

6. The silane-modified polyether sealant according to claim 4, wherein the filler is at least one of ground calcium carbonate (GCC), nano calcium carbonate (NCC), quartz powder, silica, titanium dioxide (TD) and carbon black.

7. A method for preparing the silane-modified polyether sealant comprising: adding the following parts by weight of raw materials: 15-30 parts of silane-modified polyether resin; 10-20 parts of plasticizer; and 30-70 parts of filler into a stirring reactor at room temperature; stirring under vacuum for 3-10 min, heating up to 100-110° C., dehydrating under vacuum for 2-3 h; and cooling down to 25-50° C.;
adding the following parts by weight of raw materials: 0.5-2 parts of drying agent; 1-3 parts of adhesion promoter and 0.1-0.5 parts of catalyst in sequence; and stirring for 20-40 min under vacuum to obtain the silane-modified polyether sealant.

8. The method of claim 7, wherein the adhesion promoter is prepared by the following method: adding N-β-(aminoethyl)-γ-aminopropyltrimethoxysilane, 2-(3,4-epoxycyclohexane)ethyltrimethoxysilane, n-octyltriethoxysilane and water in a molar ratio of 1:(0.4-0.6):(0.4-0.6):(0.25-0.35) into a three-necked flask; stirring at 50-60° C. under nitrogen for 2-3 h; and cooling down to obtain the adhesion promoter.

9. The method of claim 8, wherein the molar ratio of the N-β-(aminoethyl)-γ-aminopropyltrimethoxysilane, 2-(3,4-epoxycyclohexane)ethyltrimethoxysilane, n-octyltriethoxy-silane and water is 1:0.5:0.5:0.3.

10. The method of claim 7, wherein the plasticizer is at least one of diisononyl phthalate (DINP), diisodecyl phthalate (DIDP), diisononyl cyclohexane 1,2-dicarboxylate (DINCH) and polypropylene glycol (PPG); the drying agent is vinyl trimethoxysilane (VTMS).

11. The method of claim 7, wherein the filler is at least one of ground calcium carbonate (GCC), nano calcium carbonate (NCC), quartz powder, silica, titanium dioxide (TD) and carbon black.

12. The method of claim 7, wherein the catalyst is prepared by the following method: adding dibutyltin dilaurate (DBTDL), stannous octoate and primary dodecyl amine into a three-necked flask in a mass ratio of (4-6):(4-6):3, and stirring at 10-20° C. under nitrogen for 1-2 h to obtain the catalyst.

13. The method of claim 12, wherein the mass ratio of the DBTDL, stannous octoate and primary dodecyl amine is 5:5:3.

14. The method of claim 7, wherein the silane-modified polyether sealant according to claim 1, wherein the silane-modified polyether resin is a silane-terminated polyether with hydrolysable trimethoxy as a terminal group.

15. The method of claim 14, wherein the adhesion promoter is prepared by the following method: adding N-β-(aminoethyl)-γ-aminopropyltrimethoxysilane, 2-(3,4-epoxycyclohexane)ethyltrimethoxysilane, n-octyltriethoxysilane and water in a molar ratio of 1:(0.4-0.6):(0.4-0.6):(0.25-0.35) into a three-necked flask; stirring at 50-60° C. under nitrogen for 2-3 h; and cooling down to obtain the adhesion promoter.

16. The method of claim 15, wherein the molar ratio of the N-β-(aminoethyl)-γ-aminopropyltrimethoxysilane, 2-(3,4-epoxycyclohexane)ethyltrimethoxysilane, n-octyltriethoxy-silane and water is 1:0.5:0.5:0.3.

17. The method of claim 14, wherein the plasticizer is at least one of diisononyl phthalate (DINP), diisodecyl phthalate (DIDP), diisononyl cyclohexane 1,2-dicarboxylate (DINCH) and polypropylene glycol (PPG); the drying agent is vinyl trimethoxysilane (VTMS).

18. The method of claim 14, wherein the filler is at least one of ground calcium carbonate (GCC), nano calcium carbonate (NCC), quartz powder, silica, titanium dioxide (TD) and carbon black.

19. The method of claim 14, wherein the catalyst is prepared by the following method: adding dibutyltin dilaurate (DBTDL), stannous octoate and primary dodecyl amine into a three-necked flask in a mass ratio of (4-6):(4-6):3, and stirring at 10-20° C. under nitrogen for 1-2 h to obtain the catalyst.

20. The method of claim 19, wherein the mass ratio of the DBTDL, stannous octoate and primary dodecyl amine is 5:5:3.
